(19) United States
(12) Patent Application Publication
(10) Pub. No.: US 2024/0289515 A1
(43) Pub. Date: Aug. 29, 2024

(54) METHOD FOR DETERMINING A DEMAND FOR FILLING MATERIAL

(71) Applicant: Opitz Packaging Systems GmbH, Kalefeld (DE)

(72) Inventors: Stephan Westphal, Clausthal-Zellerfeld (DE); Martin Dahmen, Göttingen (DE); Günther Opitz, Kalefeld (DE)

(21) Appl. No.: 18/573,238

(22) PCT Filed: May 27, 2022
(86) PCT No.: PCT/EP2022/064483

§ 371 Date: Dec. 21, 2023

(30) Foreign Application Priority Data
Jul. 9, 2021 (DE) 102021117821.5

(51) Int. Cl. G06F 30/20; G06F 113/20

(52) U.S. Cl. CPC G06F 30/20; G06F 2113/20

(57) ABSTRACT

A method for determining a demand for filling material in order to, when filling a shipping container, which has been in part pre-filled with products, secure the position of the products in the shipping container, comprises at least partially detecting the remaining space in the shipping container which is not occupied by the products, and determining the filling material required to at least partially fill the detected space. A three-dimensional grid is virtually generated which represents the portion of the remaining space in the interior of the shipping container which is not occupied by the products and which is accessible from above in the vertical direction. The method also comprises generating virtual spatial candidate elements which are suitable for filling, in various sub-combinations, the grid within specified tolerances and without collision, and selecting a sub-combination of this kind as result combination.

### FIELD OF THE INVENTION

The invention relates to a method for determining a demand for filling material in order to, when filling a shipping container, which has been in part pre-filled with products, with this filling material, secure the position of the products in the shipping container, comprising the steps of:
at least partially detecting the remaining space in the shipping container which is not occupied by the products,
determining the filling material required to at least partially fill the detected space.

### Prior Art

Such a method is known from DE 10 2011 055 455 A1, for example.

In the context of the ever-increasing delivery business, methods for automated packaging of individually assembled products in shipping cartons are of increasing importance. Typically, shipping containers, e.g., folding boxes made of cardboard, which are roughly adapted in their volume to the total volume of the products to be packed, are typically filled with an individual compilation of products to be sent. This can be done manually or—nowadays usually—by corresponding robots. However, in almost every case, a space remains in the interior of the shipping container that is not occupied by the products. It is customary to fill this remaining space with filling material in order to secure the position of the products in the shipping container and to avoid a sliding of the products that produces rattling noises during further handling of the container closed for the purpose of being shipped.

It is known to fill filling material, e.g., creped paper, air cushion film, air cushions, filler chips, or the like, manually in a suitable quantity and/or shape into the shipping container in order to fill the remaining space at least to such an extent that the products are sufficiently prevented from slipping during normal handling of the container.

The generic document mentioned at the outset discloses an automated method in which the volume of the remaining space is optically determined, in a manner not explained in detail, and a corresponding volume of pourable filling material is measured and filled. However, pourable filling materials, such as plastic chips, are to be assessed critically due to the waste quantities occurring. However, even in the case of biologically degradable, pourable filling material, such as, for example, popcorn, the recipient is confronted with a soiling and disposal problem during unpacking that is perceived as annoying.

The use of specifically-dimensionable filling material, such as creped paper or ready-to-assemble air cushion pads, is regarded as particularly favorable. However, no automated method is known for their use.

### Object

It is the object of the present invention to provide an automated method for determining the demand for filling material which can be used in particular in the context of individually-dimensionable filling materials.

### Presentation of the Invention

This object is achieved in conjunction with the features of the preamble of claim 1 in that a three-dimensional grid is virtually produced which represents the portion of space remaining outside the products in the vertical direction, which portion is accessible from above, in the interior of the shipping container, wherein the method further comprises the phases of:
I generating virtual spatial candidate elements which are suitable for filling, in various sub-combinations, the grid within specified tolerances and without collision, and
II selecting a sub-combination of this kind as a result combination.

Preferred embodiments are the subject matter of the dependent claims.

The invention is based upon the following concept for an automated packing process, which is shown in a roughly simplified manner here and explained in detail below. For an automated packaging process, (only) the vertically accessible portion of the remaining space is determined.

Many different, simply-shaped, virtual filling bodies are then generated which—each per se—can be used at certain positions in the remaining space or its virtual representation. From this pool of virtual filling bodies, many different sub-combinations are virtually tried and evaluated, with each leading to a (partial) filling of the space. The best-rated combination is then implemented by producing real filling bodies corresponding to the virtual filling bodies (including selection from a previously generated supply) and by inserting them by robot-support vertically from above at a corresponding location in the real space. The method preferably follows a heuristic approach which does not have the goal of determining the objectively best solution, but of determining, in a short, reproducible time, a solution good enough in practice.

A core idea of the invention is first to take into account (and accordingly, also only to determine) that portion of the remaining space which is accessible from above in the vertical direction when the shipping container is open. Terms such as “above” and “below” in the context of the present description refer to the vertical direction specified by gravity. The inventors have recognized that it is generally not necessary to completely fill the entire remaining space, i.e., in particular, also those regions which are covered by products located in the shipping container and protruding laterally in a stack, with filling material. On the one hand, typical packing algorithms work in such a way that products taking up a large surface are at the bottom, and products taking up a smaller area are positioned further above in the container, so that only extremely rarely are large, undercut regions created. On the other hand, it has been found that-especially in the case of use of large, elastic filling bodies, such as for example those made from creped paper-a sufficient position securing of the products can be achieved even without explicit consideration of such undercut regions.

In the context of the method according to the invention, the only portion taken into consideration of the remaining space, which portion is directly accessible vertically from above, is detected as such and modeled virtually by a three-dimensional grid. The distances of the grid points are to be selected by a person skilled in the art in view of the requirements of the individual case, wherein a narrower distribution of the grid points results in a finer, but also more time-consuming calculation, and a coarse grid structure leads more quickly to more approximate results. The grid points are preferably distributed in such a way that the walls of each unit cell of the grid stand parallel to the walls of the shipping container-more precisely, to the inner surfaces thereof.

The grid is preferably generated on the basis of an image which is provided by means of a TOF camera under which the pre-filled shipping container is guided in the open state. TOF is an abbreviation meaning in English, time of flight, which is known to the person skilled in the art and denotes cameras which, as output, supply a two-dimensional pixel matrix, the individual pixel values of which represent the distance of the object point imaged on the pixel to the camera. By subtracting the distance of the camera from the upper edge of the shipping container, a depth image of the shipping container interior including the products already positioned therein can be created, from which the three-dimensional grid according to the invention can in turn be calculated in a manner obvious to the person skilled in the art.

The further method built upon this grid can be subdivided into two phases, viz., a generation phase I and a selection phase II. In phase I, virtual, spatial candidate elements are first generated. These are, in simplified terms, virtual formed bodies of different shapes and sizes, by means of which the virtual grid can be at least partially filled in different combinations, without the virtual formed bodies substantially overlapping with one another or with the walls of products and/or shipping container. The extent to which an overlap is permitted in the context of this virtual modeling depends upon the preset tolerances which, in turn, depend upon the properties of the real filling bodies which are used in the real implementation of the filling of the shipping container. In this sense, the term, “within specified tolerances,” is to be understood as “collision-free.” At the end of phase I, a pool with a preferably large number of different virtual candidate elements is thus available.

In a subsequent phase II, from the sub-combinations of virtual candidate elements, with which the grid can be filled in the context of the specified tolerances, one particularly advantageous is selected and is provided as output as a result combination of the determination method according to the invention. In particular, in the context of an actual packaging process, it can be provided that said resulting combination be output to a packaging unit, by means of which real filling bodies corresponding to the virtual candidate elements of the resulting combination are then generated and positioned in the shipping container according to the result combination. The person skilled in the art will recognize from this that the term, sub-combination of virtual candidate elements, not only relates to the compilation of a group of candidate elements, but also to their spatial arrangement in the grid.

Particularly favorable implementations of the two method phases are to be discussed further below.

As already indicated above, the method according to the invention follows a purely heuristic approach. The result combination is not necessarily the objectively best solution according to predefined evaluation criteria. However, a sufficiently good solution is found with great reliability, and this within a particularly short computing time. This is a very essential criterion for practical use. In automated packaging systems, for economical operation, a very high throughput must be realized. Delivery of shipping containers and their pre-filling with an individual compilation of products can already be carried out in a fast manner. In order not to constitute a costly bottleneck for the overall method, it must be possible to fill the shipping containers with filling material for securing the position of the products at a comparable pace. This means that only extremely little time is available both for the detection of the remaining space and for the determination of the required filling material, as well as for the real filling process. The method according to the invention not only allows holding to a computing time required for determining the filling material demand, which is short, i.e., below a predefined maximum time, and reproducible, i.e., substantially similar, independently of the individual pre-filling of the shipping container. It also provides solutions that can be implemented particularly quickly in the context of the real filling process, e.g., by using only a few, comparatively large, filling bodies from a robot arm in correspondingly few working cycles instead of many small filling bodies in correspondingly more working cycles. In this case, the ultimately found solution may not be optimal, neither with regard to the position securing of the products nor with regard to the shortness of the overall process; however, with great reliability, a solution that is completely sufficient in practice is found, which-especially in automated methods—is an important quality criterion, regardless of the individual pre-filling of the shipping containers in a working cycle that is specified at another level.

According to a preferred embodiment of the invention, it is provided that phase I comprise:
a) the steps iteratively performed until all enlargement directions are blocked
   a1) selecting a grid point and occupying it with a virtual filling body, which, in the first iteration, is a filling body of minimum starting size and the walls of which are parallel to the walls of a virtual representation of the shipping container,
   a2) selecting an enlargement direction perpendicular to a wall of the virtual filling body, stepwise increasing the virtual filling body by moving the wall in the enlargement direction until a predetermined termination criterion is reached, and blocking the selected enlargement direction for subsequent iteration steps,
b) storing the thus enlarged virtual filling body as a virtual candidate element, and
c) repeating steps I.a and I.b until a predetermined termination criterion is reached.

Metaphorically speaking, to generate a virtual candidate element, a minimally-dimensioned nucleus is thus positioned at a-preferably randomly selected-position in the grid. The selection of the exact dimensioning of this nucleus, which, in terms of its outer shapes, resembles the interior of the shipping container, is substantially free for the person skilled in the art. However, it is recommended that there be an adaptation to the distances of the grid points that provide a natural grid unit cell which can be used as said nucleus, i.e., said virtual filling body of minimal starting size.

Starting from this nucleus, the virtual filling body is enlarged stepwise in a-preferably randomly selected-enlargement direction perpendicular to one of its walls. With regard to the choice of the step size, a person skilled in the art is largely free. However, the adaptation to the grid and in particular the stepwise enlargement by a grid point distance in the enlargement direction is also recommended here. After a predefined termination criterion has been reached, the enlargement process ends in the current enlargement direction and is blocked for the subsequent iteration steps. In particular, as a termination criterion, the virtual filling body colliding with a virtual representation of a wall of the shipping container or of a product and/or reaching a predefined maximum size is to be considered in this case. In other words, the virtual filling body should grow in the current enlargement direction only until it “abuts” against the shipping container or a product (more precisely: against its virtual representation). Alternatively or additionally, the reaching of a maximum size of the virtual filling body can also serve as a termination criterion. This maximum size can be introduced largely arbitrarily, but preferably depends upon the practical possibilities of implementing the virtual filling body in a real filling body which could possibly be used for real filling of the shipping container.

This enlargement process is carried out in all possible enlargement directions, so that an enlarged, virtual filling body results which is stored in a pool as a virtual candidate element.

In this way, all virtual candidate elements are generated and stored in the pool. In a practical implementation of the method, such a pool can contain several thousand virtual candidate elements. The termination criterion for the generation phase I can, for example, be the reaching of a predefined plurality of different filling bodies in the pool or the achievement of a predefined number of repetitions of steps I.a and I.b.

With respect to the selection phase, it is preferably provided that phase II comprise:
a) the iterative steps of selecting a virtual candidate element and the position of the selected virtual candidate element in the grid, which steps are carried out in a collision-free manner in the context of predetermined tolerances, until a sub-combination meeting a predefined termination criterion is present,
b) at least temporarily storing the resulting sub-combination,
c) repeating steps II.a and II.b until a predetermined termination criterion is reached.
d) evaluating the stored sub-combinations according to predetermined evaluation criteria, and
e) identifying the best-rated sub-combination as a result combination to be output.

The basic principle of phase II is to generate and evaluate a large number of sub-combinations of virtual candidate elements possibly suitable for conversion into a real filling process. The generation should take place largely randomly. A pool of sub-combinations is created, which are evaluated according to suitably specified assessment criteria with regard to their benefits in concrete packaging problems. The best-rated sub-combination is then identified as a result combination and output as a result of the method according to the invention. In this case, one candidate element is initially, and preferably randomly, selected from the pool of virtual candidate elements and positioned at a preferably randomly-selected position of the grid. If this is possible without a collision (in the context of predefined tolerances) with virtual representations of shipping container and product walls, the first candidate element is left in place, and a further virtual candidate element is selected from the pool-preferably randomly—and is positioned in a position, also preferably randomly selected, in the grid. If this is also possible without collision (in the context of predetermined tolerances), wherein collisions with the previously positioned virtual candidate element are now also included, the process is repeated, etc. If there is a collision at some point, either the entire sub-combination can be stored as concluded in the pool of sub-combinations, or the colliding virtual candidate element can first be removed and replaced by another. In any case, when a predefined termination criterion is reached, the sub-combination achieved up until then is stored in said pool of sub-combinations, and the establishment of a further sub-combination begins according to the method described.

Possible termination criteria which lead to storing a sub-combination can consist in the current sub-combination comprising a predefined number of virtual candidate elements, in reaching a predefined maximum volume of the sub-combination, and/or the grid being filled to a predefined minimum spatial proportion. Already when the sub-combination is stored, a preselection can be made, so that obviously unsuitable sub-combinations do not reach the aforementioned pool of sub-combinations at all.

The aforementioned, and preferably random, selection of the candidate elements for cooperation at a sub-combination can preferably take place in that, at the beginning of each iteration, i.e., at the beginning of each building of a new sub-combination, a randomly-ordered list of virtual candidate elements of the pool is set up, and these are processed in the predetermined order in the context of the iteration. On the one hand, this ensures the randomness of the selection of each of the virtual candidate elements; on the other, a separate random generator step is not required for each new virtual candidate element, which has an advantageous effect on the required computing time.

The termination criterion for building-up the pool of sub-combinations can preferably consist in that a predefined number of stored sub-combinations is reached.

Various evaluation criteria can be used when evaluating the sub-combinations stored in the pool of sub-combinations. It has proven to be particularly favorable if these evaluation criteria comprise that the evaluated sub-combination
has the smallest possible number of virtual candidate elements,
has the smallest possible degree of collision of the virtual candidate elements among one another and/or with virtual representations of the shipping container and the products, and/or
fills as large a spatial proportion of the grid as possible.

Other and/or additional evaluation criteria, which can be incorporated into the overall evaluation according to a predetermined weighting, can be provided by a person skilled in the art—in particular, during the implementation of the result combination in a real filling process.

The person skilled in the art will understand that the build-up of the pool of sub-combinations and their evaluation do not necessarily have to represent partial phases taking place in succession. It is thus not necessary to permanently store all generated sub-combinations. For example, an initially only temporary storage and direct evaluation of each newly-generated sub-combination and comparison with the previously best, long-term stored sub-combination is also conceivable, wherein the new sub-combination replaces the previous best in long-term memory in the event that it is evaluated as better. Storage space can thus be saved.

In any case, the sub-combination ultimately evaluated as best is provided as a result combination for output to subsequent process units.

The result of the determination method according to the invention thus consists in a virtual representation of filling bodies in a very specific spatial configuration, which-according to the goal of the method-largely fills the space remaining in the real shipping container around the products arranged there.

In the context of a real packaging system, this result combination can be output to a packing unit which in turn has two (functional) sub-units, viz., one which is able to generate real filling bodies corresponding to the virtual candidate elements of the result combination and one which is able to arrange these real filling bodies in the spatial configuration specified by the result combination in the shipping container. The latter is generally implementable by a multi-axis robot arm. The former can be designed as a separate technical unit or can also be realized in the sense of a purely functional unit by the robot arm interacting with a corresponding filling material store.

Preferably, the unit has a creping device, by means of which web-shaped, creped filling material, e.g., paper, is cut to length and creped to form real filling bodies of predefined dimensions. Alternatively or additionally, it can be provided that the packaging unit comprise an air cushion producing assembly by means of which contiguous air cushion filling material is packaged into real filling bodies of predefined dimensions.

Further details and advantages of the invention emerge from the following specific description and the drawings.

### BRIEF DESCRIPTION OF THE DRAWINGS

In the drawings:

FIG. 1 shows a shipping container pre-filled with products during image detection by means of the TOF camera,

FIG. 2 shows a plan view of the shipping container of FIG. 2,

FIG. 3 shows a plane of a grid representing the remaining space in the shipping container of FIGS. 1 and 2,

FIG. 4 shows four enlargement steps in a first enlargement direction in the context of the generation of a candidate element,

FIG. 5 shows three further enlargement steps in a second enlargement direction in the context of the generation of the candidate element,

FIG. 6 shows the candidate element resulting after completion of all enlargement steps,

FIG. 7 shows a symbolic representation of a candidate element pool,

FIG. 8: shows a symbolic representation of a selection process for selecting the result combination, and

FIG. 9: shows the implementation of the result combination of FIG. 8 in a real filling process for the shipping container of FIG. 1.

### DESCRIPTION OF PREFERRED EMBODIMENTS

Identical reference signs in the figures indicate identical or analogous elements.

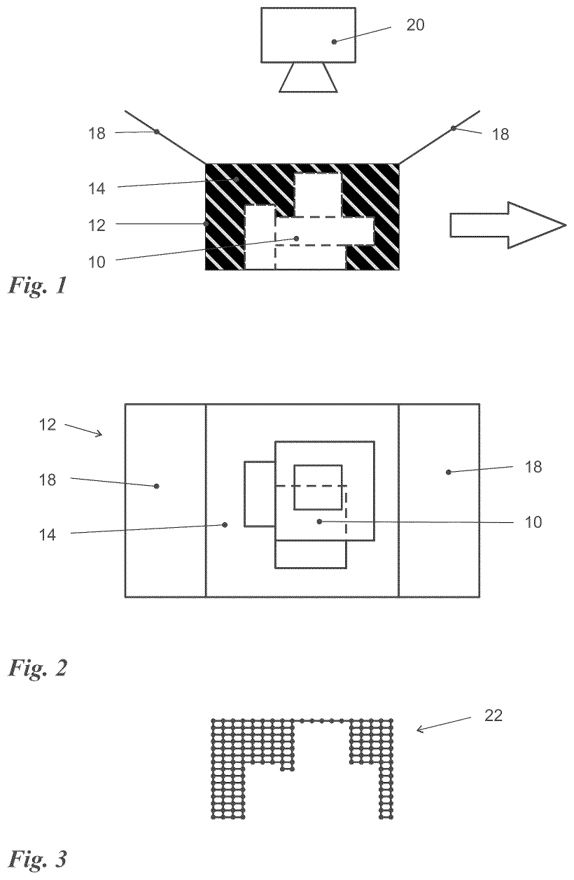

FIGS. 1, 2, and 9 show two situations within a real packaging process, viz., the provision of a shipping container 12 pre-filled with products 10 to be shipped (FIGS. 1 and 2), and the filling of space 14 remaining between the products 10 and the wall of the shipping container 12 with real filling bodies 16 (FIG. 9).

FIGS. 3 through 8 symbolically show central steps of a preferred embodiment of the method according to the invention for determining the demand for filling material for the position-securing filling of the remaining space 14 in the shipping container 12. A shipping container 12, e.g., a folding box made of cardboard, with individually assembled products 10 is pre-filled in a preferably automated pre-filling method, which is not shown in detail and is generally known to the person skilled In the art. Although the dimensions of the shipping container 12 are roughly adapted to the total volume of the products 10, no space-filling pre-filling is generally possible. Rather, a space 14 remains between the products among each other and relative to the wall of the shipping container 12. This remaining space 14 is shown in FIG. 1 with shaded lines. A shipping container 12 pre-filled in this way is preferably guided on a conveyor belt or a roller conveyor with open upper flaps 18 under a TOF camera 20 (time-of-flight camera). A TOF image of the plan view on the shipping container 12 shown in FIG. 2 is created. As already explained in the context of the general description, the TOF camera provides a two-dimensional, ordered matrix, wherein each matrix entry corresponds to the distance of the object point imaged on the corresponding pixel in the interior of the shipping container 12 from the camera 20. According to the invention, as shown in FIG. 3, this information is converted into a three-dimensional grid 22 which represents the portion of the remaining space 14 that is accessible from above in the vertical direction. It can be seen that regions of the remaining space 14 that are covered by protruding products are not detected (see, for example, the lower right corner of the product stack of FIG. 1). The person skilled in the art will recognize that

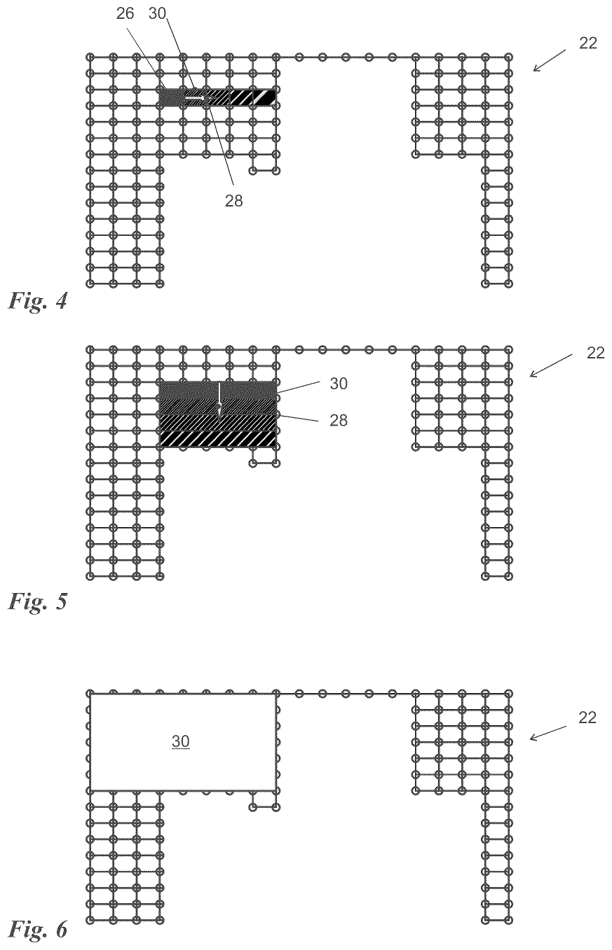

FIG. 3, just as FIGS. 4 through 6 described below, shows only a vertical sectional plane of the resulting three-dimensional grid 22.

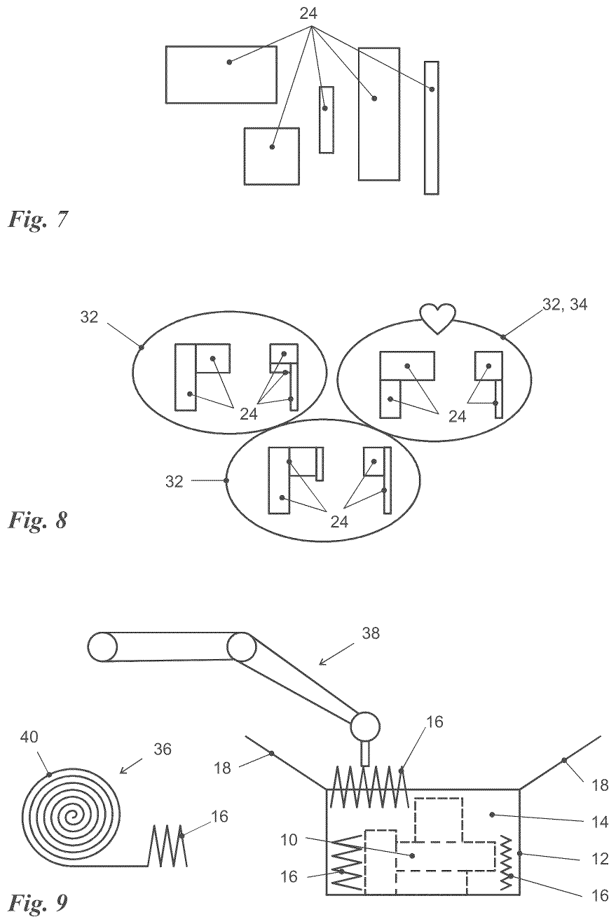

The grid 22 is the basis of a subsequent, two-phase method. In a first generation phase I shown in FIGS. 4 through 7, a pool of virtual candidate elements 24, shown symbolically in FIG. 7, is generated. For this purpose, a virtual filling body of minimum starting size 26 is preferably positioned at a randomly selected position in the grid 22, which shall also be referred to here as a nucleus 26. In the embodiment shown, the size of the nucleus 26 corresponds to a grid unit cell specified by the structure of the grid 22, wherein it is regarded as particularly favorable if the walls of the grid elementary cells are parallel to the walls of the shipping container 12.

Then, as symbolized by the direction arrow 28, a first enlargement direction is selected-preferably randomly—and the wall of the nucleus 26 pointing in the enlargement direction is displaced in the current enlargement direction by a step width-preferably by a grid elementary cell. The result is an enlarged, virtual filling body 30. In further steps, which are indicated in FIG. 4 by differently dense shading, the enlarged virtual filling body is further enlarged gradually until it abuts against an (inner) edge of the grid 22-especially against a virtual representation of the stack of products 10. At this time, the enlargement of the virtual filling body 30 in the first enlargement direction is terminated, and this first enlargement direction is blocked for further enlargement iterations.

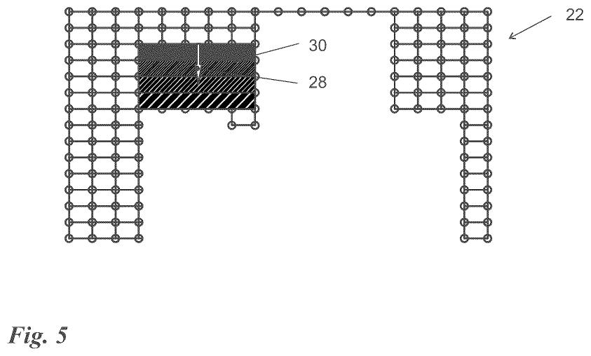

Then, as shown in FIG. 5, a further second enlargement direction symbolized by the directional arrow 28 is selected-preferably randomly—and the virtual filling body 30, already enlarged in the first enlargement direction, is now enlarged in steps in the second enlargement direction. This again takes place up to a collision or up to another predefined termination criterion. Like the first enlargement direction, the second enlargement direction is now blocked for further enlargement iterations. This process is repeated analogously until all enlargement directions have been processed and a maximally enlarged filling body 30 results, which is stored as a candidate element 24 in the pool of candidate elements shown purely symbolically in FIG. 7. A plurality of candidate elements is generated by multiple repetition of the steps described, and the pool is correspondingly filled. This generation phase I can be concluded, for example, by reaching a predefined number of candidate elements 24 in the pool.

The second phase of the method according to the invention then follows, which is also referred to here as a selection phase. From the candidate elements 24 present in the pool, sub-combinations of the candidate elements 24 are virtually inserted into the grid 22 in a random method, wherein, for each combination, which not only comprises the compilation of several candidate elements, but also their specific positioning in the grid 22, during modeling, boundary conditions can be specified, e.g., with regard to permitted and prohibited degrees of overlap of the candidate elements 24 with one another or with the edges of the grid 22. The person skilled in the art will understand that the resulting sub-combinations have different numbers of candidate elements 24 and will fill the grid 22 to different degrees. As a result, in any case, a pool of sub-combinations 32 results which is symbolically shown in FIG. 8.

These sub-combinations 32 are then evaluated according to predefined evaluation criteria, which preferably take into account the (smallest possible) filling degree of the grid 22, the (smallest possible) number of candidate elements, and/or the degree of collision (possibly within predefined tolerances) of the candidate elements 24 involved. At least one of the sub-combinations 32 examined will obtain the best evaluation. If several sub-combinations 32 obtain the same best evaluation, then the person skilled in the art can apply further, e.g., random, selection criteria. As a result, a best-rated sub-combination 34 results.

At this point, the demand determination method according to the invention ends. Its result, i.e., the best-rated sub-combination 34, can then be output as a result combination 34 to a real packaging unit, which is shown in FIG. 9 and comprises two units in the embodiment shown, viz., a filling body generation unit which is specifically designed as a creping device 36 in the embodiment shown, and a positioning unit which, in the specific embodiment, is designed as a robot arm 38. By means of the creping device 36, packaging paper is cut to length by a roller 40 and creped so that a real filling material 16 results which corresponds to one of the virtual candidate elements 24 of the best-rated sub-combination 34. By means of the robot arm 38, this real filling body 16 is then inserted into the remaining space 14, corresponding to the position of the corresponding candidate element 24 of the best-rated sub-combination 34 in the grid 22. In this way, the best-rated sub-combination 34 is converted from virtual candidate elements into a real filling of the remaining space 14 with real filling bodies.

Of course, the embodiments discussed in the specific description and shown in the figures represent only illustrative exemplary embodiments of the present invention. In light of the present disclosure, a broad spectrum of possible variations is provided to the person skilled in the art. In particular, any technical solution is available to a person skilled in the art for converting the best-rated sub-combination 34 of virtual candidate elements 24 into a specific filling process with real filling bodies 16. As an alternative to creped paper filling bodies, suitable air cushion filling bodies are particularly suitable.

### LIST OF REFERENCE SIGNS

10 product
12 shipping container
14 remaining space
16 real filling body
18 flap
20 TOF camera
22 grid
24 virtual candidate element
26 virtual filling body of minimum starting size/nucleus
28 direction arrow
30 enlarged virtual filling body
32 sub-combination
34 best-rated sub-combination/result combination
36 creping device
38 robot arm
40 packaging paper roll

1. Method for determining a demand for filling material in order to, when filling a shipping container, which has been in part pre-filled with products, with this filling material, secure the position of products in the shipping container, comprising the steps of:
at least partially detecting the remaining space in the shipping container which is not occupied by the products,
determining the filling material required to at least partially fill the detected space, wherein a three-dimensional grid is virtually generated which represents the portion of the remaining space in the interior of the shipping container which is not occupied by the products and which is accessible from above in the vertical direction,
wherein the method further comprises the following phases:
I generating virtual spatial candidate elements which are suitable for filling the grid in various sub-combinations without collisions within predetermined tolerances, and
II selecting a sub-combination of this kind as a result combination.

2. Method according to claim 1, wherein the grid is generated on the basis of an image taken of the shipping container by means of a TOF camera under which the pre-filled shipping container is guided in the open state.

3. Method according to claim 1 wherein phase I comprises:
the steps iteratively performed until all enlargement directions are blocked
a1) selecting a grid point and occupying the same with a virtual filling body, which is a filling body of minimum starting size during the first iteration and the walls of which are parallel to the walls of a virtual representation of the shipping container,
a2) selecting a non-blocked enlargement direction perpendicular to a wall of the virtual filling body, stepwise enlarging of the virtual filling body by moving the wall in the enlargement direction until a predetermined termination criterion is met and blocking the selected enlargement direction for subsequent iteration steps,
storing the thus enlarged virtual filling body as a virtual candidate element, and repeating steps I.a and I.b until a predetermined termination criterion is reached.

4. Method according to claim 3, wherein the selection of the grid point in step I.a1 and/or the selection of the enlargement direction in step I.a2 takes place randomly.

5. Method according to claim 3, wherein the termination criterion for step I.a2 consists in that the virtual filling body collides with a virtual representation of a wall of the shipping container or of a product and/or a predefined maximum size of the virtual filling body is reached.

6. Method according to claim 3, wherein the termination criterion for step I.c consists in that a predefined plurality of different virtual filling bodies or a predetermined number of iterations is reached.

7. Method according to claim 1, wherein phase II comprises:
the steps of selecting a virtual candidate element and of collision-free positioning, within predefined tolerances, of the selected virtual candidate element in the grid-, which steps are carried out iteratively until a sub-combination fulfilling a predefined termination criterion is present,
at least temporarily storing the resulting sub-combination,
repeating steps II.a and II.b until a predetermined termination criterion is reached,
evaluating the stored sub-combinations according to predetermined evaluation criteria, and
identifying the best-rated sub-combination as a result combination to be output.

8. Method according to claim 7, wherein the termination criterion in step II.a consists in that the sub-combination comprises a predetermined number of virtual candidate elements, a predefined maximum volume of the sub-combination is reached, and/or the grid is filled to a predetermined minimum spatial proportion.

9. Method according to claim 7, wherein the selection of each virtual candidate element in step II.a takes place randomly.

10. Method according to claim 9, wherein the selection of the virtual candidate elements takes place in that a randomly-ordered list of the virtual candidate elements is set up at the beginning of the iteration, and these are processed in the predetermined order in the context of the iteration.

11. Method according to claim 7, wherein the termination criterion in step II.c consists in that a predetermined number of stored sub-combinations is reached.

12. Method according to claim 7, wherein the evaluation criteria comprise that the evaluated sub-combination
has the smallest possible number of virtual candidate elements,
has the smallest possible degree of collision of the virtual candidate elements among one another and/or with virtual representations of the shipping container and the products, and/or
fills as large a spatial proportion of the grid as possible.

13. Method for filling with filling material a shipping container partially pre-filled with products in order to secure the position of the products in the shipping container, comprising the steps of:
performing a determination method according to claim 1,
outputting the result combination to a packaging unit, by means of which real filling bodies corresponding to the virtual candidate elements of the result combination are then generated and are positioned in the shipping container according to the result combination.

14. Method according to claim 13, wherein the packaging unit has a creping device by means of which web-shaped, creped filling material is cut to length and creped to form real filling bodies of predefined dimensions.

15. Method according to claim 13, wherein the packaging unit comprises an air cushion assembly by means of which contiguous air cushion filling material is packaged into real filling bodies of predefined dimensions.
